(19) United States
(12) Patent Application Publication
(10) Pub. No.: US 2025/0150299 A1
(43) Pub. Date: May 8, 2025

(54) HOUSEHOLD APPLIANCE WITH RESTRICTED FUNCTIONALITIES

(71) Applicant: ELECTROLUX APPLIANCES AKTIEBOLAG, Stockholm (SE)

(72) Inventor: Livio PLOS, Porcia (IT)

(73) Assignee: ELECTROLUX APPLIANCES AKTIEBOLAG, Stockholm (SE)

(21) Appl. No.: 18/725,947

(22) PCT Filed: Jan. 4, 2022
(86) PCT No.: PCT/EP2022/050052

§ 371 Date: Jul. 1, 2024

(51) Int. Cl. H04L 12/28; H04W 4/02; H04W 4/33; H04W 4/80; H04W 12/06; H04W 12/63

(52) U.S. Cl. CPC H04L 12/282; H04W 4/023; H04W 4/33; H04W 4/80; H04W 12/06; H04W 12/63

(57) ABSTRACT

A household appliance is disclosed. The household appliance includes a control unit configured to control an operation of the household appliance based on at least one restricted functionality settable between a non-selectable mode in which selection of the at least one restricted functionality is prevented and a selectable mode in which selection of the at least one restricted functionality is restricted to one or more authorized users, and a short-range radio signal module configured to receive short-range radio signals from a user device associated with the household appliance, where either the control unit or the short-range radio signal module is configured to estimate a position of the user device based on the short-range radio signals received at the short-range radio signal module and based on the position of the user device, determine a presence or absence of the user device in proximity of the household appliance.

### FIELD OF THE INVENTION

The present invention generally relates to the field of household appliances. Particularly, the present invention relates to a household appliance with one or more restricted functionalities, i.e. functionalities the selection of which is restricted (or allowed only) to one or more authorized users.

### BACKGROUND OF THE INVENTION

Some household appliances currently on the market, such as cooking appliances (e.g., induction cooking hobs or ovens) and laundry appliances (e.g., washing machines, drying machines or combined washing/drying machines) may be communicably coupled to user devices, such as mobile devices (e.g., smartphones) or wearable devices (e.g., smartwatch), to allow a remote interaction between users (e.g., the owners of the user devices) and the household appliances.

By remote interaction between a user and a household appliance it is herein meant an interaction between the user and the household appliance taking place through a virtual user interface, such as a virtual interface provided by a software application running on the user device.

Examples of remote interaction between a user and a household appliance may comprise a remote monitoring of the household appliance by the user, and/or a remote control of the household appliance by the user.

However, remote interaction between a household appliance and a user (and, particularly, remote control of the household appliance by the user) is usually not allowed for functionalities (hereinafter, restricted functionalities) of the household appliance that (e.g., due to safety requirements) require user attendance, i.e. the physical presence of the user near or in proximity of the household appliance.

Examples of restricted functionalities may comprise a switching on or start of operation of the household appliance, one or more options/settings of the household appliance, and/or one or more treatment cycles or programs of the household appliance.

### SUMMARY OF INVENTION

The Applicant has realized that the household appliances currently on the market provide access to the restricted functionalities only through physical user interfaces of the household appliances, whereas the remote control of the household appliances by the users is limited to a subset of functionalities (hereinafter referred to as open functionalities) that are deemed to be safely accessible by any users.

According to the Applicant, this affects user experience during remote interaction, in that no complete remote control is allowed to the users.

Moreover, the Applicant has understood that providing access to the restricted functionalities only through the physical user interfaces of the household appliances does not prevent unallowed uses of the restricted functionalities to persons who are unfamiliar with technology (such as the elderly) and/or who are forbidden to use them for safety rules/standards (such as the children and/or the kids).

In view of the above, the Applicant has devised a household appliance allowing selection of one or more restricted functionalities of the household appliance (e.g., through the physical user interface and/or through the virtual user interface) if a user device is determined to be in proximity of the household appliance, and if the person in proximity of the user device is an authorized user being authorized to select said one or more restricted functionalities.

Particularly, an aspect of the present invention relates to a household appliance.

According to an embodiment, the household appliance comprises a control unit configured to control an operation of the household appliance based on at least one restricted functionality.

According to an embodiment, the at least one restricted functionality is settable between a non-selectable mode in which selection of the at least one restricted functionality is prevented and a selectable mode in which selection of the at least one restricted functionality is restricted to one or more authorized users.

According to an embodiment, the household appliance comprises a short-range radio signal module.

According to an embodiment, the short-range radio signal module is configured to receive short-range radio signals from a user device associated with the household appliance.

According to an embodiment, either the control unit or the short-range radio signal module is configured to estimate a position of the user device based on the short-range radio signals received at the short-range radio signal module.

According to an embodiment, either the control unit or the short-range radio signal module is configured to, based on the position of the user device, determine a presence or absence of the user device in proximity of the household appliance.

According to an embodiment, either the control unit or the short-range radio signal module is configured to, if the presence of the user device in proximity of the household appliance is determined, cause the user device to check an identity of a person in proximity of the user device.

According to an embodiment, either the control unit or the short-range radio signal module is configured to, if, based on the checked identity, the person in proximity of the user device is an authorized user among said one or more authorized users, set the at least one restricted functionality in the selectable mode.

According to an embodiment, the at least one restricted functionality comprises a plurality of restricted functionalities.

According to an embodiment, the selection of each one of said plurality of restricted functionalities set in the selectable mode is restricted to a respective subset of said one or more authorized users.

According to an embodiment, the control unit is configured to determine a presence or absence of the user device in proximity of the household appliance if, based on the user device position, the user device is determined to be inside or outside, respectively, an attending area that allows the authorized user to attend operation of the household appliance.

According to an embodiment, the short-range radio signals comprise at least one among NFC, RFID, Bluetooth, ZigBee, and ultra-wideband (UWB) radio signals.

According to an embodiment, the position of the user device estimated by the control unit or the short-range radio signal module comprises at least one between distance and angular position of the user device relative to the household appliance.

According to an embodiment, the control unit is configured to cause the user device to check an identity of a person in proximity of the user device by causing the user device to run a biometric recognition procedure.

According to an embodiment, the at least one restricted functionality comprises at least one among a switching on of the household appliance, an option, a treatment cycle or program.

According to an embodiment, the user device comprises a mobile device, such as a smartphone, a tablet or a wearable device.

Another aspect of the present invention relates to a method for the remote interaction with a household appliance.

According to an embodiment, the method comprises receiving, at the household appliance, short-range radio signals from a user device associated with the household appliance.

According to an embodiment, the method comprises estimating, at the household appliance, a position of the user device based on the short-range radio signals received at the household appliance.

According to an embodiment, the method comprises, based on the position of the user device, determining, at the household appliance, a presence or absence of the user device in proximity of the household appliance.

According to an embodiment, the method comprises, if the presence of the user device in proximity of the household appliance is determined, causing the user device to check an identity of a person in proximity of the user device.

According to an embodiment, the method comprises if, based on the checked identity, the person in proximity of the user device is an authorized user among one or more authorized users, setting, at the household appliance, at least one restricted functionality of the household appliance from a non-selectable mode in which selection of the at least one restricted functionality is prevented to a selectable mode in which selection of the at least one restricted functionality is restricted to said one or more authorized users.

### BRIEF DESCRIPTION OF THE ANNEXED DRAWINGS

These and other features and advantages of the present invention will be made apparent by the following description of some exemplary and non-limitative embodiments thereof; for its better intelligibility, the following description should be read referring to the attached drawings, wherein:

FIG. 1 shows a system according to an embodiment of the present invention, and

FIG. 2 shows an activity diagram of a method according to an embodiment of the present invention.

### DETAILED DESCRIPTION OF PREFERRED EMBODIMENTS OF THE PRESENT INVENTION

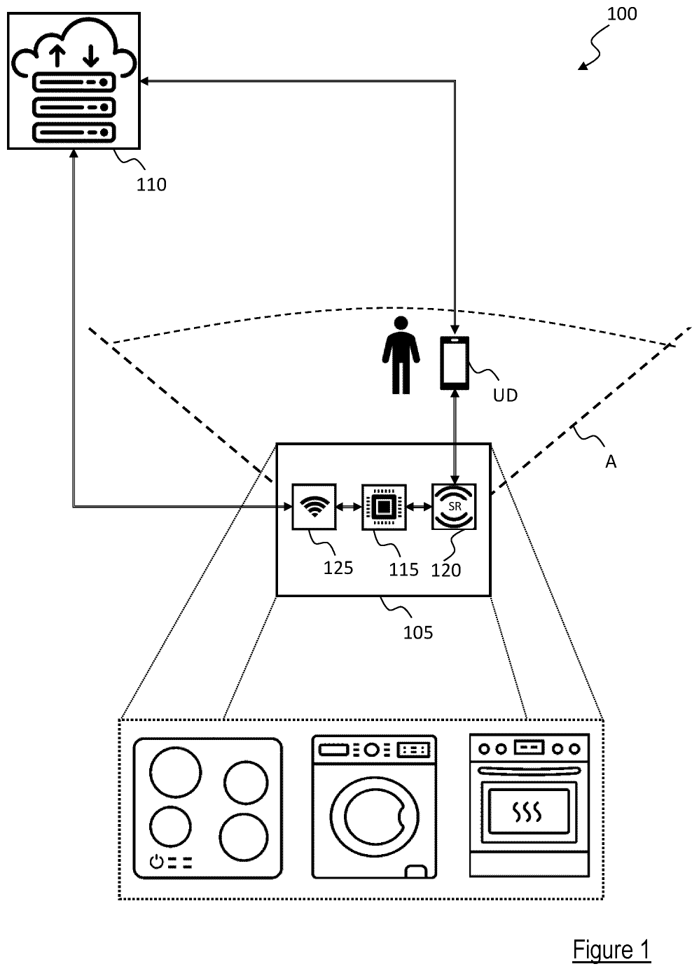

With reference to the drawings, FIG. 1 shows a system 100 according to an embodiment of the present invention.

In the following, when one or more features of the system (as well as of parts thereof and/or method steps implemented thereby) are introduced by the wording “according to an embodiment”, they are to be construed as features additional or alternative to any features previously introduced, unless otherwise indicated and/or unless there is evident incompatibility among feature combinations.

According to an embodiment, the system 100 comprises a household appliance 105. In the following, only components of the household appliance 105 deemed relevant for the understanding of the present invention will be discussed for the sake of conciseness.

As schematically represented in the figure by way of example only, the household appliance 105 may comprise a cooking appliance (such as an induction cooking hob or an oven), or a laundry appliance (such as a washing machine, a drying machine or a combined washing/drying machine), although this should not be construed limitatively.

According to an embodiment, the system 100 comprises a user device UD.

According to an embodiment, the user device UD comprises a mobile device, such as a smartphone (as exemplarily illustrated), a personal digital assistant (PDA), a tablet, or a wearable device (such as a smartwatch).

According to an embodiment, the household appliance 105 and the user device UD are communicably coupled to each other, for example through one or more wireless communication links (such as Wi-fi, Bluetooth and/or cellular communication links) and/or wired communication links.

According to an embodiment, the household appliance 105 and the user device UD are communicably coupled to each other to allow a remote interaction between a user (e.g., a owner of the user device UD) and the household appliance 105.

By remote interaction between the user and the household appliance 105 it is herein meant an interaction between the user and the household appliance 105 taking place through a virtual user interface (not shown). According to an embodiment, the virtual user interface, as opposed to a physical user interface (not shown) which may be physically provided on the household appliance (and which typically forms a control panel of the household appliance), may be provided by a software application running on the user device UD (such as a mobile application running on a mobile device).

Just as an example, the remote interaction between the user and the household appliance 105 may comprise a remote monitoring of the household appliance 105 by the user (in which case the user may remotely check, e.g. through his/her own user device, one or more among current and/or historical status, current and/or historical operation parameters, current and/or historical events, and current and/or historical errors of the household appliance).

Just as an another example, the remote interaction between the user and the household appliance 105 may comprise (e.g., additionally or alternatively to the remote monitoring) a remote control of the household appliance 105 by the user (in which case the user, e.g. through his/her own user device, may remotely start or stop or delay or program the operation of the household appliance, and/or set one or more operation parameters of the household appliance).

Just as a further example, the remote interaction between the user and the household appliance 105 may comprise (e.g., additionally or alternatively to the remote monitoring and/or the remote control) a remote authorization of the user. As better discussed in the following, the remote authorization is aimed at checking an identity of the person who is using or is in proximity of the user device UD.

According to an embodiment, the household appliance 105 and the user device UD are communicably coupled to each other through one or more short-range radio signal communication links to allow a nearby or proximity interaction between the user device UD and the household appliance 105 (e.g., in order to determine a position of the user device with respect to the household appliance, as better discussed in the following).

According to an embodiment, the user device UD is configured to run a biometric recognition procedure, i.e. a procedure that allows recognition and/or identification of one or more users based on one or more biometric identifiers of the users.

Examples of biometric identifiers include, but are not limited to, fingerprint, face, hand geometry, iris and retina.

According to an embodiment, as better discussed in the following, the user device UD is configured to run the biometric recognition procedure during the remote authorization of the user.

According to an embodiment, the system 100 comprises a computing structure, such as a server, 110.

According to an embodiment, the household appliance 105 and the server 110 are communicably coupled to each other through respective one or more wireless communication links (such as Wi-fi and/or cellular communication links) and/or wired communication links.

According to an embodiment, communicable coupling between the server 110 and the household appliance 105 allows the appliance manufacturer to deliver one or more services (such as software/firmware update of the household appliance, and/or information to the user).

According to an embodiment, the user device UD and the server 110 are communicably coupled to each other through respective one or more wireless communication links (such as Wi-fi and/or cellular communication links) and/or wired communication links.

According to an embodiment, communicable coupling between the user device UD and the server 110, and between the server 110 and the household appliance 105 allows said remote interaction between the user and the household appliance 105.

According to an embodiment, the household appliance 105 comprises a control unit 115 configured to control an operation of the household appliance 105.

According to an embodiment, the control unit 115 is configured to control the operation of the household appliance 105 according to instructions received by the user through a user interface of the household appliance 105. As mentioned above, the user interface may for example comprise a physical user interface and/or a virtual user interface.

According to an embodiment, the control unit 115 is configured to control the operation of the household appliance 105 based on a plurality of functionalities of the household appliance 105.

According to an embodiment, the plurality of functionalities may comprise one or more functionalities of the household appliance 105 that can be freely accessed or selected by any users (hereinafter referred to as open functionalities).

For the purposes of the present disclosure, the plurality of functionalities comprises (additionally or alternatively to the open functionalities) one or more functionalities of the household appliance 105 that are restricted to (i.e., that can be accessed or selected only by) one or more authorized users (hereinafter, restricted functionalities).

According to an embodiment, each restricted functionality is settable or configurable (e.g., by the control unit 115) between a non-selectable mode in which selection of the restricted functionality is prevented (for any users), and a selectable mode in which selection of the restricted functionality is restricted to one or more authorized users.

According to an embodiment, the selection of each restricted functionality (set in the selectable mode) may be restricted to a respective subset of the authorized users.

According to an embodiment, the restricted functionalities may comprise functionalities that (e.g., due to safety requirements) require user attendance, i.e. the physical presence of the user near or in proximity of the household appliance 105.

According to an embodiment, the restricted functionalities may comprise a switching on or start of operation of the household appliance 105. Just as an example, user attendance may be required for a laundry appliance to ensure that the operation of the laundry appliance starts without foreign bodies in the drum and/or in the detergent drawer. Just as another example, user attendance may be required for a cooking appliance to ensure that the operation of the cooking appliance starts without foreign bodies in the cooking cavity (e.g., in case the cooking appliance is an oven) and/or on the cooking zones (e.g., in case the cooking appliance is an induction cooking hob).

According to an embodiment, the restricted functionalities may comprise (additionally or alternatively to the switching on or start of operation of the household appliance 105) one or more options/settings of the household appliance 105: examples of options/settings the selection of which may be restricted to one or more authorized users may comprise high or relatively spin speeds of a laundry appliance, and/or power boost of a cooking appliance, and/or or definition and/or setting of cooking zones of an induction cooking hob.

According to an embodiment, the restricted functionalities may comprise (additionally or alternatively to the switching on or start of operation of the household appliance 105, and to one or more options/settings of the household appliance 105) one or more treatment cycles or programs of the household appliance 105: examples of treatment cycles or programs the selection of which may be restricted to one or more authorized users may comprise high-temperature and/or long-duration and/or high-water consumption laundry treatment cycles of a laundry appliance, and/or automatic cooking programs of a cooking appliance (i.e., cooking programs having predefined and fixed duration and/or power profile).

According to an embodiment, the restricted functionalities are set in the non-selectable mode by default.

According to an embodiment, the household appliance 105 comprises a short-range radio signal module (hereinafter concisely referred to as SR module) 120 configured to receive short-range radio signals (hereinafter concisely referred to as SR signals) from the user device UD. According to an embodiment, the SR module 120 may be configured to exchange (i.e., transmit and receive) the SR signals with the user device UD.

According to an embodiment, the SR signals may comprise ultra-wideband (UWB) radio signals. According to an embodiment, the SR signals may comprise, additionally or alternatively to the UWB radio signals, one or more among NFC, RFID, Bluetooth, and ZigBee radio signals. Without losing generality, the SR signals may be compliant with IEEE802.15.4 standard and/or 6LoWPAN protocol.

According to an embodiment, not shown, the household appliance 105 may comprise, additionally or alternatively to the SR module 120, a signal module (not shown) configured to receive (e.g., from the user device UD) further signals other than the SR signals. Without losing generality, these further signals may comprise one or more among sound signals (such as ultrasound signals) and light signals.

According to an embodiment, the control unit 115 and the SR module 120 are communicably coupled to each other (e.g., through a corresponding communication bus).

According to an embodiment, the control unit 115 (and/or the SR module 120) is configured to estimate a position of the user device UD based on the SR signals received at the SR module 120 (and/or based on the further signals received at the signal module, when provided). According to an embodiment, the position of the user device UD estimated by the control unit 105 (and/or by the SR module 120) comprises at least one between distance and angular position of the user device UD relative to the household appliance 105.

According to an embodiment, the control unit 115 is configured to determine, based on the position of the user device UD, a presence or absence of the user device UD in proximity of the household appliance 105. According to an embodiment, the control unit 115 is configured to determine a presence or absence of the user device UD in proximity of the household appliance 105 if, based on the position of the user device UD, the user device UD is determined to be inside or outside, respectively, an attending area A that allows (or is considered to allow) a user to attend operation of the household appliance 105.

An example of attending area A is illustrated in FIG. 1 by dashed lines.

The attending area A may have any shape and/or size. Without losing generality, the shape and size of the attending area A may depend on the type of household appliance 105: just as an example, the attending area A may be smaller or narrower for a cooking appliance than for a laundry appliance.

According to an embodiment, as mentioned above, if the presence of the user device UD in proximity of the household appliance 105 is determined, the control unit 115 is configured to cause the user device UD to check an identity of a person in proximity of the user device (e.g., by causing the user device UD to run the biometric recognition procedure), and to determine if, based on the checked identity, the person in proximity of the household appliance 105 is an authorized user among the authorized users (remote authorization of the user).

According to an embodiment, as better discussed in the following, if, based on the checked identity, the person in proximity of the household appliance 105 is an authorized user, the control unit 115 is configured to set one or more of the restricted functionalities in the selectable mode.

According to an embodiment, the household appliance 105 comprises a communication module 125 (for example, a Wi-fi and/or cellular communication module) for allowing the comunicable coupling between the household appliance 105 and the server 110 (e.g., as discussed above, so as to allow the appliance manufacturer to deliver one or more services, and/or to allow said remote interaction between the user, thorugh his/her own user device UD, and the household appliance 105).

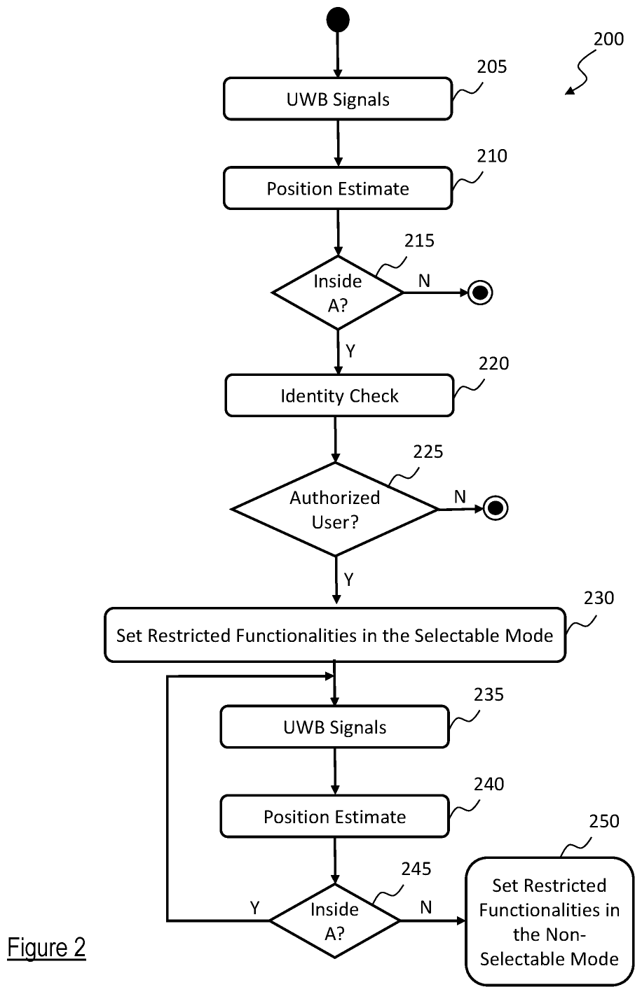

With reference now to FIG. 2, it shows an activity diagram of a method 200 according to an embodiment of the present invention.

Broadly speaking, as mentioned above, the method 200 is aimed at setting one or more restricted functionalities of the household appliance 105 in the selectable mode (e.g., from the default, non-selectable mode) if a user device (e.g., a user device associated with the household appliance, as better discussed in the following) is determined to be in proximity of the household appliance 105, and if the person in proximity of the user device (and, hence, of the household appliance 105) is one of the authorized users being authorized to select said one or more restricted functionalities.

In the following, by setting one or more restricted functionalities of the household appliance 105 in the selectable mode it is herein meant that said one or more restricted functionalities are selectable through the physical user interface provided on the household appliance and/or through the virtual user interface.

Setting the restricted functionalities in the selectable mode only if the presence of an authorized user in proximity of the household appliance is determined, prevents unallowed uses of the restricted functionalities to persons who are unfamiliar with technology (such as the elderly) and/or who are forbidden to use them for safety rules/standards (such as the children and/or the kids). Indeed, irrespective of whether the restricted functionalities are made selectable through the physical user interface and/or through the virtual user interface, selection of the restricted functionalities is necessarily performed by the authorized user (or at least upon consent of the attending authorized user).

According to an embodiment, the method 200 comprises receiving SR signals (such as UWB signals) at the household appliance 105 (e.g., at the SR module 120 thereof) (action node 205).

According to an embodiment, if SR signal reception at the household appliance 105 is disabled by default, SR signal reception at the household appliance 105 (action node 205) may comprise enabling SR reception upon occurrence of one or more events (in the following, triggering events). Examples of triggering events may comprise access by the user to a menu or submenu that allows selecting one or more among the restricted functionalities.

According to an embodiment, if SR signal reception at the household appliance 105 is enabled by default, SR signal reception at the household appliance 105 (action node 205) may comprise continuously receiving the SR signals.

According to an embodiment, the SR signals are received from one or more user devices associated with the household appliance 105.

According to an embodiment, a user device associated with the household appliance 105 may be a user device that, e.g. during a standard or dedicated registration or subscription process, is set or selected by the user as the entity in charge of transmitting the SR signals to the household appliance 105 for position determination purposes. Additionally or alternatively, a user device associated with the household appliance 105 may be the user device where the software application allowing the remote interaction between the user and the household appliance 105 has been installed and logged-in by the user with a corresponding registered account.

According to an embodiment, the SR signals are transmitted by a user device or processed by the household appliance 105 upon ascertaining that the user device is a user device (e.g., one of the user devices) associated with the household appliance 105.

According to an embodiment, when SR transmission from the user devices is disabled by default, the method 200 may comprise, upon occurrence of the triggering event, determining which user device is associated with the household appliance 105, and triggering or causing the or any user device(s) associated with the household appliance 105 to transmit the SR signals.

According to an embodiment, when SR transmission from the user devices is enabled by default, the method 200 may comprise processing the received SR signals upon ascertaining that the user device(s) transmitting the SR signals is a user device (e.g., one of the user devices) associated with the household appliance 105.

Just as an example, said ascertaining that a user device transmitting the SR signals is associated with the household appliance 105 may be performed by (or under the control of) the control unit 115 based on registration or subscription information stored in the software application installed in the user device and/or in the server 110.

Ascertaining that a user device transmitting the SR signals is a user device associated with the household appliance 105 before reception or processing of the SR signals at the household appliance 105, allows avoiding that the household appliance 105 receives and processes SR signals from user devices owned by persons that are not supposed to be authorized users (for example, guests of the user owning the household appliance 105).

According to an embodiment, the method 200 comprises estimating, e.g. at the control unit 115 and/or at the SR module 120, the position of the user device UD based on the SR signals received at the SR module 120 (action node 210).

As mentioned above, the (estimated) position of the user device UD may comprise distance and/or angular position of the user device UD relative to the household appliance 105.

According to an embodiment, the method 200 comprises determining, based on the position of the user device UD, the position of the user device UD with respect to the attending area A (decision node 215).

According to an embodiment, if, based on the position of the user device UD, the user device UD is determined to be outside the attending area A (exit branch N of the decision node 215), the absence of the user device UD (and, hence, of the respective user) in proximity of the household appliance 105 is determined, whereby the method 200 ends without setting any restricted functionality of the household appliance 105 in the selectable mode.

According to an embodiment, if, based on the position of the user device UD, the user device UD is determined to be inside the attending area A (exit branch Y of the decision node 215), the presence of the user device UD in proximity of the household appliance 105 is determined, thereafter the method 200 comprises checking the identity of the person in proximity of the user device UD (remote authorization) (action node 220).

According to an embodiment, the identity of the person in proximity of the user device UD is checked by the user device UD.

According to an embodiment, the identity of the person in proximity of the user device UD is checked by the user device UD upon request or invitation by the control unit 115.

According to an embodiment, as mentioned above, the control unit 115 is configured to cause the user device UD to check the identity of the person in proximity of the user device UD by causing the user device UD to run the biometric recognition procedure.

Just as an example, the biometric recognition procedure may comprise a notification on the user device UD. The notification may for example be a push notification, such as a banner on the top of the device screen and/or dialog box that interrupts and blocks the view of any running application, and may contain text and/or vocal and/or image message (possibly with the further playing of an alert sound to attract the attention of the user). According to an embodiment, the user may confirm or deny the start of the biometric recognition. Just as an example, the biometric recognition procedure may be started by touching on the notification or by means of other gesture (for example, by means of a sliding on the notification box). As mentioned above, biometric recognition may be based, for example, on recognition of fingerprints, face, hand geometry, iris or retina.

Checking the identity of the person in proximity of the user device UD through the biometric recognition procedure allows avoiding that a person who is not the owner of the user device UD and who has not the consent of the owner to use it (such as children and/or kids) is wrongly determined as an authorized user when such a person is near the household appliance 105 together with the user device UD.

According to an embodiment, if, based on the checked identity, the person in proximity of the household appliance 105 is not an authorized user (exit branch N of decision node 225), the method 200 ends without setting any restricted functionality of the household appliance 105 in the selectable mode.

According to an embodiment, if, based on the checked identity, the person in proximity of the household appliance 105 is an authorized user (exit branch Y of the decision node 225), the method 200 comprises setting (e.g., by the control unit 115) one or more of the restricted functionalities in the selectable mode (action node 230). As mentioned above, according to an embodiment, the selection of each restricted functionality (when set in the selectable mode) may be restricted to a respective subset of the authorized users: in this embodiment, the setting of the one or more of the restricted functionalities in the selectable mode performed at action node 230 may comprise setting a subset of the restricted functionalities in the selectable mode depending on which one of the authorized users is (determined to be) in the proximity in the household appliance 105.

According to an embodiment, the restricted functionalities may be kept in the selectable mode until the household appliance 105 is switched off.

According to an embodiment, the restricted functionalities may be kept in the selectable mode until the end of the treatment cycle or program performed after setting the restricted functionalities in the selectable mode.

According to an embodiment, as exemplary illustrated in FIG. 2, the restricted functionalities may be kept in the selectable mode until the authorized user is determined to be outside the attending area A (nodes 235-250).

According to an embodiment, after setting the restricted functionalities in the selectable mode (action node 230), the method 200 may comprise, upon reception of the SR signals at the household appliance 105 (action node 235, analogous to action node 205), and upon estimating the position of the user device UD (action node 240, analogous to action node 210), (re)determining the position of the user device UD with respect to the attending area A (decision node 245, analogous to action node 215).

According to an embodiment, if, based on the position of the user device UD, the user device UD is still determined to be inside the attending area A (exit branch Y of the decision node 245), nodes 235-245 are reiterated as such based on the (following) SR signals transmitted by the user device UD (as conceptually illustrated in the figure by loop connection between the exit branch Y of the decision node 245 and the action node 235).

According to an embodiment, if, based on the position of the user device UD, the user device UD is determined to be outside the attending area A (exit branch N of the decision node 215), which means that the user may have left the attending area A, the method 200 may comprise setting the restricted functionalities (i.e., the restricted functionalities previously set in the selectable mode) in the non-selectable mode (action node 250).

Naturally, in order to satisfy local and specific requirements, a person skilled in the art may apply to the invention described above many logical and/or physical modifications and alterations. More specifically, although the invention has been described with a certain degree of particularity with reference to preferred embodiments thereof, it should be understood that various omissions, substitutions and changes in the form and details as well as other embodiments are possible. In particular, different embodiments of the invention may even be practiced without the specific details (such as the numeric examples) set forth in the preceding description for providing a more thorough understanding thereof; on the contrary, well known features may have been omitted or simplified in order not to obscure the description with unnecessary particulars.

For example, the household appliance and/or the system may have a different structure or include equivalent components. Moreover, any component of the household appliance and/or the system may be separated into several elements, or two or more components may be combined into a single element; furthermore, each component can be replicated to support the execution of the corresponding operations in parallel. It should also be noted that (unless otherwise indicated) any interaction between different components generally does not need to be continuous and may be either direct or indirect through one or more intermediaries.

Moreover, the present invention lends itself to be implemented through an equivalent method (by using similar steps, removing some steps being not essential, or adding further optional steps); moreover, the steps may be performed in different order, concurrently or in an interleaved way (at least partly).

1. A household appliance comprising:
a control unit configured to control an operation of the household appliance based on at least one restricted functionality settable between a non-selectable mode in which selection of the at least one restricted functionality is prevented and a selectable mode in which selection of the at least one restricted functionality is restricted to one or more authorized users, and
a short-range radio signal module configured to receive short-range radio signals from a user device associated with the household appliance, wherein either the control unit or the short-range radio signal module is configured to:
estimate a position of the user device based on the short-range radio signals received at the short-range radio signal module;
based on the position of the user device, determine a presence or absence of the user device in proximity of the household appliance;
if the presence of the user device in proximity of the household appliance is determined, cause the user device to check an identity of a person in proximity of the user device, and if, based on the checked identity, the person in proximity of the user device is an authorized user among said one or more authorized users, set the at least one restricted functionality in the selectable mode.

2. The household appliance according to claim 1, wherein the at least one restricted functionality comprises a plurality of restricted functionalities, the selection of each one of said plurality of restricted functionalities set in the selectable mode being restricted to a respective subset of said one or more authorized users.

3. The household appliance according to claim 1, wherein the control unit is configured to determine a presence or absence of the user device in proximity of the household appliance if, based on the user device position, the user device is determined to be inside or outside, respectively, an attending area that allows the authorized user to attend operation of the household appliance.

4. Household The household appliance according to claim 1, wherein the short-range radio signals comprise at least one among NFC, RFID, Bluetooth, ZigBee, and ultra-wideband (UWB) radio signals.

5. The household appliance according to claim 1, wherein the position of the user device estimated by the control unit or the short-range radio signal module comprises at least one between distance and angular position of the user device relative to the household appliance.

6. The household appliance according to claim 1, wherein the control unit is configured to cause the user device to check an identity of a person in proximity of the user device by causing the user device to run a biometric recognition procedure.

7. The household appliance according to claim 1, wherein the at least one restricted functionality comprises at least one among a switching on of the household appliance, an option, a treatment cycle or program.

8. The household appliance according to claim 1, wherein the user device comprises a mobile device, such as a smartphone, a tablet or a wearable device.

9. A method for remote interaction with a household appliance, comprising:
receiving, at the household appliance, short-range radio signals from a user device associated with the household appliance;
estimating, at the household appliance, a position of the user device based on the short-range radio signals received at the household appliance;
based on the position of the user device, determining, at the household appliance, a presence or absence of the user device in proximity of the household appliance;
if the presence of the user device in proximity of the household appliance is determined, causing the user device to check an identity of a person in proximity of the user device, and
if, based on the checked identity, the person in proximity of the user device is an authorized user among one or more authorized users, setting, at the household appliance, at least one restricted functionality of the household appliance from a non-selectable mode in which selection of the at least one restricted functionality is prevented to a selectable mode in which selection of the at least one restricted functionality is restricted to said one or more authorized users.
